(19) United States
(12) Patent Application Publication
(10) Pub. No.: US 2010/0210795 A1
(43) Pub. Date: Aug. 19, 2010

(54) GAS-PHASE PROPYLENE POLYMERIZATION PROCESS USING STAGED ADDITION OF ALUMINUM ALKYL

(76) Inventors: Michel Clarembeau, Temploux (BE); Jerome A. Streeky, Bolingbrook, IL (US); Andreas B. Ernst, South Elgin, IL (US)

Correspondence Address: INEOS USA LLC, 3030 WARRENVILLE RD, S/650, LISLE, IL, 60532, US

(21) Appl. No.: 12/449,387

(22) PCT Filed: Mar. 3, 2008
(86) PCT No.: PCT/US2008/002803

§ 371 Date: Apr. 12, 2010

Related U.S. Application Data
(60) Provisional application No. 60/905,286, filed on Mar. 6, 2007.

(51) Int. Cl. C08F 2/34

(52) U.S. Cl. 526/65

(57) ABSTRACT

An olefin polymerization process comprises gas-phase polymerization of at least one olefin monomer in more than one polymerization zones using a high activity Ziegler-Natta catalyst system comprising a solid, magnesium-supported, titanium-containing component and an aluminum alkyl component comprising introducing the titanium-containing component and an aluminum alkyl component into the first polymerization zone and then introducing additional aluminum alkyl component into a subsequent polymerization zone without added titanium-containing component.

### FIELD OF THE INVENTION

This invention relates to polymerization of olefins and particularly relates to gas-phase polymerization of propylene including copolymerization with alpha-olefins and ethylene using a high activity titanium-containing catalyst component together with staged addition of aluminum alkyl co-catalyst in order to control product distribution among one or more stages.

### BACKGROUND OF THE INVENTION

Manufacture of numerous types of thermoplastic olefin polymers now is well known and routinely commercially practiced based on Ziegler-Natta catalyst systems. Useful commercial manufacturing processes for olefin polymers using Ziegler-Natta catalysts have evolved from complex slurry processes using an inert hydrocarbon diluent, to efficient bulk processes using liquid propylene diluent, to even more efficient gas-phase processes in which solid polymer is formed directly from polymerizing gaseous olefin monomer.

Typically-used gas-phase processes include horizontally and vertically stirred sub-fluidized bed reactor systems, fluidized bed systems, as well as multi-zone circulating reactor systems. Thermoplastic olefin polymers made in these processes include polymers of ethylene and C3-C10+ alpha-olefin monomers and include copolymers of two or more of such monomers, such as statistical (random) copolymers or multi-phasic (rubber-modified or impact) copolymers.

Polymers of propylene, which contain crystalline polypropylene segments, are advantageously produced in the gas phase. Such propylene polymers include polypropylene homopolymer in which essentially all of the monomer units are propylene and copolymers of propylene with up to fifty mole percent (50 mole %) of one or more of ethylene or C4+ olefin monomer. Usually, propylene/ethylene copolymers contain up to about 30 wt. %, typically up to about 20 wt. %, of ethylene monomer units. Depending on the desired use, such copolymers may have a random or statistical distribution of ethylene monomer units or may be composed of an intimate mixture of homopolymer and random copolymer chains, typically referred to as rubber-modified or impact copolymers. In such rubber-modified or impact copolymers, typically a high ethylene content random copolymer functions as an elastomeric or rubber component to alter the impact properties of the combined polymer material.

In propylene polymerizations, stereoregularity of the propylene units in the polymer chain affects product properties. The extent of stereoregularity measured as isotacticity or an isotactic index may be regulated by process conditions such as an amount or composition of a stereoregulating modifier such as a silane.

Also molecular weight of an olefin polymer, especially propylene polymers, typically is regulated by use of hydrogen in the polymerization gas mixture. A higher concentration of hydrogen will result in a lower molecular weight. The molecular weight distribution of the polymer composition, sometimes referred to as polydispersity, may affect polymer properties.

Polymer compositions containing polymer components with different physical properties have been found to have desirable properties. Thus, total polymer compositions containing different amounts of individual polymers in a multimodal distribution may result in a polymer with properties, which are distinct from any of the polymer components. A conventional method of producing multimodal polymers is to blend individual polymers by physical means, such as a blender or blending extruder. A more efficient method of obtaining a multimodal product composition is to produce the product directly in polymerization reactors. In such in situ production, many times a more intimate mixture may be produced, which produces more advantageous properties than are able to be produced by physical blending.

Producing a multimodal product typically requires a process in which polymerization occurs with different conditions at different times or places in the process. Although a single reactor may be used in a batch process to simulate a multi-reactor continuous process, typically batch processes are not practical commercially. A multi-reactor system may be used, which uses two or more reactor vessels.

Gas-phase or vapor-phase olefin polymerization processes are disclosed generally in “Polypropylene Handbook” pp. 293-298, Hanser Publications, NY (1996), and more fully described in “Simplified Gas-Phase Polypropylene Process Technology” presented in Petrochemical Review, March, 1993. These publications are hereby incorporated herein by reference.

A gas-phase reactor system may function as a plug-flow reactor in which a product is not subject to backmixing as it passes through the reactor and that conditions at one part of the reactor may be different from conditions at another part of the reactor. An example of a backmixed system is a fluidized bed reactor such as described in U.S. Pat. Nos. 4,003,712 and 6,284,848 or a multi-zone system as described in U.S. Pat. No. 6,689,845. An example of a substantially plug-flow system is a horizontal, stirred, subfluized bed system such as described in U.S. Pat. Nos. 3,957,448; 3,965,083; 3,971,768; 3,970,611; 4,129,701; 4,101,289; 4,130,699; 4,287,327; 4,535,134; 4,640,963; 4,921,919, 6,069,212, 6,350,054; and 6,590,131. All of such patents are incorporated by reference herein. Although a single reactor may be used in a batch process to simulate a multi-reactor continuous process in which different conditions are used at different times during a polymerization, typically batch processes are not practical commercially.

The term plug-flow reactor refers to reactors for conducting a continuous fluid flow process without forced mixing at a flow rate such that mixing occurs substantially only transverse to the flow stream. Agitation of the process stream may be desirable, particularly where particulate components are present; if done, agitation will be carried out in a manner such that there is substantially no back-mixing. Perfect plug flow cannot be achieved because the diffusion will always lead to some mixing, the process flow regime being turbulent, not laminar. Since perfect plug flow conditions are not achieved in practice, a plug flow reactor system sometimes is described as operating under substantially plug flow conditions. Ordinarily, plug flow reactors may be disposed horizontally or vertically, and are designed such that they are longer than they are wide (the ratio of the longitudinal dimension to transverse dimension is greater than 1 and preferably greater than 2), the end located at the front of the process stream being referred to as the reactor head or front end, the exit port or take-off being located at the opposite or back end of the reactor.

Depending on manufacturing process conditions, various physical properties of olefin polymers may be controlled. Typical conditions which may be varied include temperature, pressure, residence time, catalyst component concentrations, molecular weight control modifier (such as hydrogen) concentrations, and the like.

In gas-phase olefin polymerization processes, especially propylene polymerization processes, a Ziegler-Natta catalyst system is used composed of a solid titanium-containing catalyst component and an aluminum alkyl co-catalyst component. In propylene polymerizations, which need to control the amount of polypropylene crystallinity, additional modifier components are routinely incorporated into the total catalyst system.

For polymerization of propylene, current typical catalyst systems include a high activity, magnesium halide supported, transition metal containing component, an aluminum alkyl component, and preferably an external modifier or electron donor component. A well recognized high activity propylene catalyst system is based on a solid titanium-containing component supported on a magnesium halide and contains an organic internal electron donating material. During polymerization, the solid magnesium-containing, titanium-containing, electron donor-containing component is combined with an aluminum alkyl co-catalyst component together with an external electron donating component. In typical high activity catalysts, the internal electron donating material is an alkyl phthalate and the external electron donating material is an organic silane.

In a conventional single reactor or multi-reactor gas-phase polymerization system, the solid titanium-containing component is added at the front end of a single reactor or to the first reactor of a multi-reactor system in conjunction with, but separately from, the aluminum alkyl co-catalyst component and additional modifier components. Separation of the catalyst and co-catalyst components is desirable to avoid polymerization if monomer is present in the catalyst feed lines. Typically, catalyst components are injected into a polymerization gas-phase reactor in liquid monomer.

In conventional polymerization processes, the relative amount of aluminum alkyl co-catalyst component to titanium-containing component is determined by adding sufficient quantity of co-catalyst to completely activate the titanium-containing component. Typically, adding more co-catalyst component than needed to fully activate the catalyst system does not increase polymerization activity. Thus, adding additional co-catalyst in a later polymerization stage would not increase catalyst activity if the initial catalyst had been fully activated.

Although catalyst activity decreases with residence time, adding additional catalyst (both the titanium-containing component and aluminum alkyl component) in a later polymerization stage produces undesirable product properties and operational difficulties. An additional charge of titanium-containing component would introduce a catalyst with a different range of active sites and would have different residence times. The newly-added catalyst would product polymer particles of smaller size at the end of the polymerization process train.

In olefin polymerization using a typical high activity magnesium-supported Ziegler-Natta catalyst, the rate of polymerization typically declines as a function of time, or in a continuous process, as a function of transport through the polymerization reactors. In a substantial plug flow system, such as a stirred, horizontal, sub-fluidized bed process, catalyst and co-catalyst typically are injected at one end of a reactor and polymer is transported by mechanical agitation through the reactor. Catalyst activity will decline as the polymer is transported down the reactor. In multiple reactor systems, either fluidized or non-fluidized bed systems, polymer containing active catalyst is transported from one reactor to another. If no additional catalyst is added to a subsequent reactor, the polymerization rate will decline in such subsequent reactor.

A typical kinetic model used to describe the polymerization reaction rate is a simplified model which assumes a first-order deactivation rate (kd) and first-order dependence of the reaction rate on monomer and active site concentration. Thus,

kp=kp0*e(−kd*t)

where kp is the polymerization rate (g propylene/h*bar*mg Ti), kp0 is the initial polymerization rate at a time after the process has been lined out (t=0), and kd is the first order deactivation rate.

U.S. Pat. Nos. 3,957,448 and 4,129,701 describe horizontal, stirred-bed, gas-phase olefin polymerization reactors in which catalyst and co-catalyst components may be introduced at different locations along the reactor.

U.S. Pat. No. 6,900,281 describes an olefin polymerization system in which more than one external electron donor is added in a gas-phase polymerization reaction system.

U.S. Pat. No. 5,994,482 describes producing a copolymer alloy in which donor and co-catalyst are added to both liquid pool and gas-phase reactors.

Shimizu, et al., J. Appl. Poly. Sci., Vol. 83, pp. 2669-2679 (2002) describe the influence of alkyl aluminum and alkoxysilane in Ziegler-Natta catalyst deactivation in liquid pool polymerizations.

There is a need for an olefin polymerization process in which product composition may be controlled, especially among different polymerization zones. Also, there is a need for a polymerization process which is able to control catalyst deactivation rates.

In one aspect of this invention, the kinetic profile of a gas-phase olefin polymerization is changed by multiple additions of alkylaluminum co-catalyst in different polymerization zones.

In another aspect of this invention, adding alkylaluminum co-catalyst in different polymerization zones decreases catalyst deactivation in later polymerization zones, which leads to lower total use of expensive titanium-containing catalyst component.

In another aspect of this invention, modifying reaction rates among polymerization zones will permit control of the amount of product made in each such zone and will permit control of product component distribution based on differing reaction conditions in such zones.

In another aspect of this invention, in a multiple reactor system in which polypropylene homopolymer is produced in a first reactor and a propylene/ethylene copolymer rubber component is produced in a second reactor, increasing the catalyst reactivity in the second reactor will control the amount of rubber component will be in the final product and will control the amount and distribution of ethylene units in the final product composition.

### SUMMARY OF THE INVENTION

An olefin polymerization process comprises gas-phase polymerization of at least one olefin monomer in more than one polymerization zones using a high activity Ziegler-Natta catalyst system comprising a solid, magnesium-supported, titanium-containing component and an aluminum alkyl component comprising introducing the titanium-containing component and an aluminum alkyl component into the first polymerization zone and then introducing additional aluminum alkyl component into a subsequent polymerization zone without added titanium-containing component.

### DESCRIPTION OF THE INVENTION

In the process of this invention, olefin monomer including propylene and mixtures of propylene with ethylene and other alpha-olefins are polymerized in the gas phase using a high activity Ziegler-Natta catalyst system comprising a solid, titanium-containing component in combination with at least one aluminum alkyl cocatalyst in multiple polymerization zones.

In operation of this process, solid, titanium-containing component and an aluminum alkyl component is introduced into a first polymerization zone and then additional aluminum alkyl co-catalyst is introduced into a subsequent polymerization zone. The result is that the kinetic profile of the overall polymerization is controlled such that the catalyst deactivation rate is lessened in the subsequent polymerization zone which typically results in more product produced in that zone.

As used in this invention, a polymerization zone may be a separate polymerization reactor vessel or may represent different locations in a substantially plug flow reactor, in which there are differing polymerization conditions. As an illustration, a substantially plug flow polymerization reactor as described in U.S. Pat. No. 6,900,281 does not require physically separated reaction zones, although polymerization conditions may be distinct between the front end and back end of the reactor described.

In one aspect of this invention, additional aluminum alkyl co-catalyst is introduced into a subsequent polymerization zone without additional solid titanium-containing component, but in combination with additional external modifier component such as a silane.

Control of polymerization may be accomplished by using differing amounts of co-catalyst in the first and subsequent reaction zones. As an illustration, less than the usual amount of aluminum alkyl co-catalyst component may be used the first polymerization zone followed by a higher amount of aluminum alkyl component in a subsequent zone. This will alter the relative amounts of product made in each zone. This in combination with other process conditions may alter the physical characteristics of each product made in the respective zones. As an example, effective hydrogen concentration could be different in each zone, which will result in differing molecular weights (as reflected by melt flow rates). In addition, differing amounts of co-monomer may be used in each polymerization zone. Also, polymer properties can be affected by using different silane external modifiers or by using different Si/Al molar ratios.

Another aspect of the invention is to use different aluminum alkyl co-catalyst compounds in each polymerization zone. Thus, use of the typical co-catalyst, TEA, in a second polymerization zone may be preceded by in a first polymerization zone with an aluminum alkyl co-catalyst containing C3-12 alkyls (such as tri-n-hexyl aluminum), which tend to produce a catalyst having different deactivation rates as well as ethylene polymerization response (in a propylene/ethylene copolymerization).

In the process of this invention, alkyl aluminum co-catalyst is introduced into more than one polymerization zone. In a multistage reactor system, an alkyl aluminum is added together with a titanium-containing catalyst component is a first reactor, while additional alkyl aluminum co-catalyst (which may be the same or different from the first co-catalyst) is added in a second polymerization reactor. If more than two polymerization zones are present in a polymerization system, additional co-catalyst may be added to one or more such zones.

In a plug-flow reactor or multiple plug-flow reactor systems, additional alkyl aluminum co-catalyst may be added at different locations in the plug flow reactor(s). Typically, co-catalyst is added at the front (or initial polymerization zone) of a first plug-flow polymerization reactor. Additional co-catalyst may be added in a subsequent polymerization zone in the same reactor, i.e., further down the polymerization reactor. If there is more than one reactor, additional co-catalyst also may be added to a subsequent reactor. Such added co-catalyst need not be added at the front of a second reactor, but may be added along such reactor.

The polymerization catalyst systems conventionally employed in gas-phase processes include a high activity supported solid titanium-based catalyst component, a trialkylaluminum activator or cocatalyst component and an external modifier or donor component. Separately, the catalyst components are inactive; thus, the catalyst and activator components may be suspended in propylene or a hydrocarbon liquid such as mineral oil and fed to the reactor as separate streams without initiating polymer formation in the feed lines. If desired, the titanium-containing component and aluminum alkyl component may be contacted before entering a polymerization zone, preferably, if polymerizable monomer is not present. In such case, the catalyst components are suspended in a polymerization inert hydrocarbon liquid.

Typical Ziegler-Natta catalyst systems contain a transition-metal (typically IUPAC a Group 4-6 metal) component, preferably a titanium-containing component, together with an organometallic compound such as an aluminum alkyl species. A typical and preferable titanium-containing component is a titanium halide compound, based on titanium tetrahalide or titanium trihalide, which may be supported or combined with other material. These systems are now well-known in the art.

For polymerization of olefins, high activity supported (HAC) titanium-containing components useful in this invention typically are supported on hydrocarbon-insoluble, magnesium-containing compounds. For polymerization of alpha-olefins such as propylene a solid transition metal component typically also contains an electron donor compound to promote stereospecificity. Such supported titanium-containing olefin polymerization catalyst component typically is formed by reacting a titanium (IV) halide, an organic electron donor compound and a magnesium-containing compound. Optionally, such supported titanium-containing reaction product may be further treated or modified by further chemical treatment with additional electron donor or Lewis acid species.

Suitable magnesium-containing compounds include magnesium halides; a reaction product of a magnesium halide such as magnesium chloride or magnesium bromide with an organic compound, such as an alcohol or an organic acid ester, or with an organometallic compound of metals of Groups 1, 2, or 13; magnesium alcoholates; or magnesium alkyls.

Examples of supported solid, titanium-containing catalysts are prepared by reacting a magnesium chloride, alkoxy magnesium chloride or aryloxy magnesium chloride with a titanium halide, such as titanium tetrachloride, and further incorporation of an electron donor compound. In a preferable preparation, the magnesium-containing compound is dissolved, or is in a slurry, in a compatible liquid medium, such as a hydrocarbon to produce suitable catalyst component particles. Ethylene polymerization catalysts also may be supported on oxides such as silica, alumina, or silica alumina.

Polymerization catalyst systems typically employed in gas-phase processes include a high activity supported solid titanium-based catalyst component, a trialkylaluminum activator or cocatalyst component and an external modifier or donor component. Separately, the catalyst components are inactive; thus, the catalyst and activator components may be suspended in propylene and fed to the reactor as separate streams without initiating polymer formation in the feed lines. Suitable solid supported titanium catalyst systems are described in U.S. Pat. Nos. 4,866,022, 4,988,656, 5,013,702, 4,990,479 and 5,159,021, incorporated herein by reference. These possible solid catalyst components only are illustrative of many possible solid, magnesium-containing, titanium halide-based, hydrocarbon-insoluble catalyst components useful in this invention and known to the art. This invention is not limited to a specific supported catalyst component.

In a typical supported catalyst of this invention, the magnesium to titanium atom ratio is above about 1 to 1 and may range to about 30 to 1. More preferably, the magnesium to titanium ratio ranges from about 10:1 to about 20:1. The internal electron donor components typically are incorporated into the solid, supported catalyst component in a total amount ranging up to about 1 mole per gram atom of titanium in the titanium compound, and preferably from about 0.5 to about 2.0 mole per gram atom of titanium in the titanium compound. Typical amounts of internal donor are at least 0.01 mole per gram atom of titanium, preferably above about 0.05 and typically above about 0.1 mole per gram atom of titanium. Also, typically, the amount of internal donor is less than 1 mole per gram atom of titanium, and typically below about 0.5 mole per gram atom of titanium.

The solid, titanium-containing component preferably contains from about 1 to about 6 wt. % titanium, from about 10 to about 25 wt. % magnesium, and from about 45 to about 65 wt. % halogen. Typical solid catalyst components contain from about 1.0 to about 3.5 wt. % titanium, from about 15 to about 21 wt. % magnesium and from about 55 to about 65 wt. % chlorine.

The amount of solid catalyst component to be employed varies depending on choice of polymerization technique, reactor size, monomer to be polymerized, and other factors known to persons of skill in the art, and can be determined on the basis of the examples appearing hereinafter. Typically, catalysts of this invention are used in amounts ranging from about 0.2 to 0.01 milligrams of catalyst to gram of polymer produced.

Internal electron donor materials which may be useful in this invention are incorporated into a solid, supported catalyst component during formation of such component. Typically, such electron donor material is added with, or in a separate step, during treatment of a solid magnesium-containing material with a titanium (IV) compound. Most typically, a solution of titanium tetrachloride and the internal electron donor modifier material is contacted with a magnesium-containing material. Such magnesium-containing material typically is in the form of discrete particles and may contain other materials such as transition metals and organic compounds.

Preferred electron donor compounds include esters of aromatic acids. Electron donors of mono- and dicarboxylic acids and halogen, hydroxyl, oxo-, alkyl-, alkoxy-, aryl-, and aryloxy-substituted aromatic mono- and dicarboxylic acids are preferred. Among these, the alkyl esters of benzoic and halobenzoic acids wherein the alkyl group contains 1 to about 6 carbon atoms, such as methyl benzoate, methyl bromobenzoate, ethyl benzoate, ethyl chlorobenzoate, ethyl bromobenzoate, butyl benzoate, isobutyl benzoate, hexyl benzoate, and cyclohexyl benzoate, are preferred. Other preferable esters include ethyl p-anisate and methyl p-toluate. An especially preferred aromatic ester is a dialkylphthalate ester in which the alkyl group contains from about two to about ten carbon atoms. Examples of preferred phthalate ester are diisobutylphthalate, diethylphthalate, ethylbutylphthalate and d-n-butylphthalate. Other useful internal donors are substituted diether compounds, esters of substituted succinic acid, substituted glutaric acid, substituted malonic acid, and substituted fumaric or maleic acids.

The co-catalyst component preferably is an organoaluminum compound that is halogen free. Suitable halogen-free organoaluminum compounds include, for example, alkylaluminum compounds of the formula AlR3, where R denotes an alkyl radical having 1 to 10 carbon atoms, such as, for example, trimethylaluminum (TMA), triethylaluminum (TEA) and triisobutylaluminum (TIBA).

Examples of suitable alkyl radicals, R, include methyl, ethyl, butyl, hexyl, decyl, tetradecyl, and eicosyl. Aluminum alkyls are preferred and most preferably trialkylaluminums containing 1 to about 6 carbon atoms per alkyl radical, and particularly triethylaluminum and triisobutylaluminum or a combination thereof are used. In aspects of this invention which require a combination of less active with more active aluminum alkyl components, triethylaluminum is a preferable active component and less active components including tri-n-butyl-aluminum (TNBA), tri-n-hexyl aluminum (TNHA), tri-n-octyl aluminum (TNOA), and the like.

In the process of this invention, a mixture of alkyl aluminum compounds may be used as a co-catalyst component in one or more polymerization zones. Such a mixture of alkyls can be used to control the properties of the products made in those polymerization zones. Although not preferred, but if desired, aluminum alkyls having one or more halogen or hydride groups can be employed, such as ethylaluminum dichloride, diethylaluminum chloride may be used in a co-catalyst component.

The Ziegler-Natta polymerization catalyst systems disclosed in the art for use in such processes comprise a transition metal compound component and a co-catalyst component, preferably an organoaluminum compound. Optionally, the catalyst system may include minor amounts of catalyst modifiers and electron donors. Typically, catalyst/co-catalyst components are added together or separately through one or more valve-controlled ports in the reactor vessel, located at the front of the process stream. The catalyst components may be added to the process stream through a single feedline or, more preferably, they may be injected separately through different apertures to prevent plugging in the feedlines.

Olefin monomer may be provided to the reactor through a recycled gas and quench liquid system in which unreacted monomer is removed as off-gas, partially condensed and mixed with fresh feed monomer, and injected into the reactor vessel. Hydrogen may be added to control molecular weight. A quench liquid is injected into the process stream in order to control temperature. In propylene polymerization, the quench liquid can be liquid propylene. In other olefin polymerization reactions, quench liquid can be a liquid hydrocarbon such as propane, butane, pentane or hexane, preferably isobutane or isopentane. Depending on the specific reactor system used, quench liquid can be injected into the reactor vessel above or within the bed of polymer particles.

In some applications, alkyl zinc compounds such as diethyl zinc (DEZ) may be added as an additional external modifier to produce high MFR polymer as described in U.S. Pat. No. 6,057,407, incorporated by reference herein. Use of small amounts of DEZ in combination with TEOS may be beneficial because lesser amounts of hydrogen are needed to produce high MFR polymers. Small amounts of DEZ allow high MFR polymers to be produced at lower hydrogen concentrations and higher yield.

To optimize the activity and stereospecificity of this cocatalyst system in alpha-olefin polymerization, it is preferred to employ one or more external modifiers, typically electron donors, such as silanes, mineral acids, organometallic chalcogenide derivatives of hydrogen sulfide, organic acids, organic acid esters and mixtures thereof.

Organic electron donors useful as external modifiers for the aforesaid cocatalyst system are organic compounds containing oxygen, silicon, nitrogen, sulfur, and/or phosphorus. Such compounds include organic acids, organic acid anhydrides, organic acid esters, alcohols, ethers, aldehydes, ketones, silanes, amines, amine oxides, amides, thiols, various phosphorus acid esters and amides, and the like. Mixtures of organic electron donors also may be used.

The aforesaid cocatalyst system advantageously and preferably contains an aliphatic or aromatic silane external modifier. Preferable silanes useful in the aforesaid cocatalyst system include alkyl-, aryl-, and/or alkoxy-substituted silanes containing hydrocarbon moieties with 1 to about 20 carbon atoms. Especially preferred are silanes having a formula: SiY4, wherein each Y group is the same or different and is an alkyl or alkoxy group containing 1 to about 20 carbon atoms. Preferred silanes include isobutyltrimethoxysilane, diisobutyldimethoxysilane, diisopropyldimethoxysilane, n-propyltriethoxysilane, isobutylmethyldimethoxysilane, isobutylisopropyldimethoxysilane, dicyclopentyldimethoxysilane, tetraethylorthosilicate, dicyclohexyldimethoxysilane, diphenyldimethoxysilane, di-t-butyldimethoxysilane, t-butyltrimethoxysilane, and cyclohexylmethyldimethoxysilane. Mixtures of silanes may be used.

Electron donors are employed with Ziegler-Natta catalyst systems to control stereoregularity by controlling the relative amounts of isotactic and atactic polymers (which may be measured by boiling heptane extraction or nuclear magnetic resonance (nmr) pentad analysis) in the product. The more stereoregular isotactic polymer typically is more crystalline, which leads to a material with a higher flexural modulus. Such highly crystalline, isotactic polymers also display lower melt flow rates, as a consequence of a reduced hydrogen response of the electron donor in combination with the catalyst during polymerization. The preferred electron donors of the present invention are external electron donors used as stereoregulators in combination with Ziegler-Natta catalysts. Therefore, the term “electron donor”, as used herein, refers specifically to external electron donor materials, also referred to as external donors.

Preferably, suitable external electron donor materials include organic silicon compounds, typically are silanes having a formula, Si(OR)nR′4-n, where R and R′ are selected independently from C1-C10 alkyl and cycloalkyl groups and n=1-4. Preferably, the R and R′ groups are selected independently from C2 to C6 alkyl and cycloalkyl groups such as ethyl, isobutyl, isopropyl, cyclopentyl, cyclohexyl, and the like. Examples of suitable silanes include tetraethoxysilane (TEOS), dicyclopentyldimethoxysilane (DCPDMS), diisopropyldimethoxysilane (DIPDMS), diisobutyldimethoxysilane (DIBDMS), isobutylisopropyldimethoxysilane (IBIPDMS), isobutylmethyldimethoxysilane (IBMDMS), cyclohexylmethyldimethoxysilane (CHMDMS), di-tert-butyldimethoxysilane (DTBDMS), n-propyltriethoxysilane (NPTEOS), isopropyltriethoxysilane (IPTEOS), octyltriethoxysilane (OTEOS), and the like. The use of organic silicon compounds as external electron donors is described, for example, in U.S. Pat. Nos. 4,218,339; 4,395,360; 4,328,122; and 4,473,660, all of which are incorporated herein by reference. Although a broad range of compounds are known generally as electron donors, a particular catalyst may have a specific compound or groups of compounds with which it is especially compatible and which may be determined by routine experimentation.

A typical catalyst system for the polymerization or copolymerization of alpha olefins is formed by combining the supported titanium-containing catalyst or catalyst component of this invention and an alkyl aluminum compound as a co-catalyst, together with at least one external modifier which typically is an electron donor and, preferably, is a silane. Typically, useful aluminum-to-titanium atomic ratios in such catalyst systems are about 10 to about 500 and preferably about 30 to about 300. Typically, sufficient alkyl aluminum is added to the polymerization system to activate the titanium-containing component completely.

In the process of this invention, aluminum to titanium ratios in the first polymerization zone typically are at least 10, typically at least 20 and may range up to about 300, as required for the process conditions chosen. The Al/Ti ratio for added co-catalyst may be less or more than added in the first polymerization. This ratio is calculated based on the amount of alkyl aluminum added in proportion to the amount of titanium-containing component added initially. Typical Al/Ti ratios for co-catalyst added in subsequent polymerization zones are at least 10, preferably at least 15, and typically at least 30.

In one use of this invention, a less than typical amount of co-catalyst is used in the first polymerization zone, while added co-catalyst is used in a subsequent zone. In such a system, less aluminum alkyl component than is needed to activate the titanium-containing component completely is added to a first reaction zone, while additional alkyl aluminum is added in a subsequent zone.

In one aspect, the catalyst system in the initial polymerization zone does not include sufficient aluminum alkyl co-catalyst to activate the catalyst completely for olefin polymerization. The amount needed to completely activate a catalyst system may be determined experimentally by modifying the Al/Ti ratio in the system and finding the minimum amount of aluminum alkyl which produces the maximum polymerization activity. In this aspect, the catalyst system is completely activated by adding more co-catalyst in a later polymerization zone.

In another aspect, an aluminum alkyl species having a lessened reducing ability than for example TEA is used in a first polymerization zone followed by an aluminum alkyl having a greater reducing ability in a later polymerization zone. Mixtures of aluminum alkyls may be used to further control the process.

In addition, the concentration of titanium-containing component may be higher in the first polymerization zone than typically used while the catalyst is not completely activated with co-catalyst. Adding additional co-catalyst (which may be the same or different from the first material) to a subsequent polymerization zone will increase the effective catalyst concentration in the later zone and, thus, can be used to control the process including product distribution.

Typical aluminum-to-electron donor molar ratios (e.g., Al/Si) in such catalyst systems are about 1 to about 60. Typical aluminum-to-silane compound molar ratios in such catalyst systems are above about 1.5, preferably above 2.5 and more preferably about 3. This ratio may range up to 200 or higher and typically ranges to about 150 and preferably does not exceed 120. A typical range is about 1.5 to about 20. An excessively high Al/Si or low silane quantity will cause operability problems such as low isotactic sticky powder.

The amount of the Ziegler-Natta catalyst or catalyst component of this invention to be used varies depending on choice of polymerization or copolymerization technique, reactor size, monomer to be polymerized or copolymerized, and other factors known to persons of skill in the art, and can be determined on the basis of the examples appearing hereinafter. Typically, a catalyst or catalyst component of this invention is used in amounts ranging from about 0.2 to 0.02 milligrams of catalyst to gram of polymer or copolymer produced.

The process of this invention is useful in polymerization or copolymerization of ethylene and alpha-olefins containing 3 or more carbon atoms such as propylene, butene-1, pentene-1,4-methylpentene-1, and hexene-1, as well as mixtures thereof and mixtures thereof with ethylene. Typical olefin monomers include up to C14 alpha-olefins, preferably up to C8 alpha-olefins, and more preferably up to C6 alpha-olefins. The process of this invention is particularly effective in the stereospecific polymerization or copolymerization of propylene or mixtures thereof with up to about 50 mol percent (preferably up to about 30 mol percent) ethylene or a higher alpha-olefin. According to the invention, branched crystalline polyolefin homopolymers or copolymers are prepared by contacting at least one alpha-olefin with an above-described catalyst or catalyst component with a radical generating compound under suitable polymerization or copolymerization conditions. Such conditions include polymerization or copolymerization temperature and time, pressure(s) of the monomer(s), avoidance of contamination of catalyst, the use of additives to control homopolymer or copolymer molecular weights, and other conditions well known to persons skilled in the art.

Irrespective of the polymerization or copolymerization process employed, polymerization or copolymerization should be carried out at temperatures sufficiently high to ensure reasonable polymerization or copolymerization rates and avoid unduly long reactor residence times, but not so high as to result in the production of unreasonably high levels of stereorandom products due to excessively rapid polymerization or copolymerization rates. Generally, temperatures range from about 0° to about 120° C. with a range of from about 20° C. to about 95° C. being preferred from the standpoint of attaining good catalyst performance and high production rates. More preferably, polymerization according to this invention is carried out at temperatures ranging from about 50° C. to about 80° C.

Olefin polymerization or copolymerization according to this invention is carried out at monomer pressures of about atmospheric or above. Generally, monomer pressures range from about 1.2 to about 40 bar (120 to 4000 kPa), although in vapor phase polymerizations or copolymerizations, monomer pressures should not be below the vapor pressure at the polymerization or copolymerization temperature of the alpha-olefin to be polymerized or copolymerized.

The polymerization or copolymerization time will generally range from about ½ to several hours in batch processes with corresponding average residence times in continuous processes. Polymerization or copolymerization times ranging from about 1 to about 4 hours are typical in autoclave-type reactions.

Prepolymerization or encapsulation of the catalyst or catalyst component of this invention also may be carried out prior to being used in the polymerization or copolymerization of alpha olefins. A particularly useful prepolymerization procedure is described in U.S. Pat. No. 4,579,836, which is incorporated herein by reference.

Examples of gas-phase polymerization or copolymerization processes in which the catalyst or catalyst component of this invention is useful include both stirred bed reactors and fluidized bed reactor systems and are described in U.S. Pat. Nos. 3,957,448; 3,965,083; 3,971,768; 3,970,611; 4,129,701; 4,101,289; 4,535,134; 4,640,963; 6,069,212, 6,284,848, 6,350,054; and 6,590,131, all incorporated by reference herein. Typical gas phase olefin polymerization or copolymerization reactor systems comprise at least one reactor vessel to which olefin monomer and catalyst components can be added and which contain an agitated bed of forming polymer particles. Typically, catalyst components are added together or separately through one or more valve-controlled ports in the single or first reactor vessel. Olefin monomer, typically, is provided to the reactor through a recycle gas system in which unreacted monomer removed as off-gas and fresh feed monomer are mixed and injected into the reactor vessel. For production of impact copolymers, homopolymer formed from the first monomer in the first reactor is reacted with the second monomer in the second reactor. A quench liquid, which can be liquid monomer, can be added to polymerizing or copolymerizing olefin through the recycle gas system in order to control temperature.

The reactor includes means for introducing catalyst or a catalyst component into a plurality of sections contained therein, thereby allowing a controlled introduction of catalysts and quench liquid directly into and onto the stirred, subfluidized bed of forming polymer solid and polymerizing monomer from the vapor phase in and over such bed. As the solid polymer produced in the process builds up, it traverses the reactor length and is continuously removed by passing through a take-off barrier situated at the exit end of the reactor.

The reactor may optionally be compartmented, each compartment of the reactor being physically separated by a dividing structure so constructed that it serves to control vapor intermixing between compartments but allows free polymer particle movement from one compartment to the other in the direction of the take-off. Each compartment may include one or more polymerization sections, optionally separated by weirs or other suitably shaped baffles to prevent or inhibit gross backmixing between sections.

Monomer or monomer mixture and, optionally, hydrogen are introduced largely or wholly underneath the polymer bed, and quench liquid is introduced onto the surface of the bed. Reactor off-gases are removed along the top of the reactor after removing polymer fines as completely as possible from the off-gas stream. Such reactor off-gases are led to a separation zone whereby the quench liquid is at least, in part, separated, along with any further polymer fines and some of the catalyst components, from polymerization monomer and hydrogen, if used. Monomer and hydrogen are then recycled to inlets spaced along the various polymerization sections of the reactor located generally underneath the surface of the polymer bed. A portion of the quench liquid, including the further polymer fines, is taken off the separation zone and, in major part, returned to inlets spaced along the top of the reactor compartment. A second small portion of separated quench liquid, free of polymer fines and catalyst components, may be fed into a catalyst make-up zone for catalyst diluent so that fresh quench liquid need not be introduced for that purpose. Provision may be made in the reactor to introduce the catalyst components and quench liquid at different rates into one or more of the polymerization sections to aid in the control of the polymerization temperatures and polymer production rates. Catalyst components may be added on the surface or below the surface of the bed.

The overall reactor temperature range for polymerization depends upon the particular monomer which is being polymerized and the commercial product desired therefrom and, as such, is well-known to those skilled in the art. In general, the temperature range used varies between about 40° C. up to about the softening temperature of the bed. In a multi-reactor system, different polymerization temperatures may be used in each reactor to control polymer properties in those zones.

The recycle system of the process is designed so it, together with the reactor, operates essentially isobaric. That is, preferably, there is no more than a ±70 kPa pressure change in the recycle system and reactor, more preferably ±35 kPa, which is the normal pressure variation expected from operations.

The total polymerization pressure is composed of the monomer pressure, vaporized quench liquid pressure, and hydrogen pressure together with any inert gas pressure present and such total pressure typically may vary from above about atmospheric to about 600 psig (4200 kPa). The individual partial pressures of the components making up the total pressure determine the rate at which polymerization occurs, the molecular weight, and the molecular weight distribution of the polymer to be produced.

Irrespective of polymerization or copolymerization technique, polymerization or copolymerization advantageously is carried out under conditions that exclude oxygen, water, and other materials that act as catalyst poisons. Also, according to this invention, polymerization or copolymerization can be carried out in the presence of additives to control polymer or copolymer molecular weights. Hydrogen is typically employed for this purpose in a manner well known to persons of skill in the art. Although not usually required, upon completion of polymerization or copolymerization, or when it is desired to terminate polymerization or copolymerization or at least temporarily deactivate the catalyst or catalyst component of this invention, the catalyst can be contacted with water, alcohols, acetone, or other suitable catalyst deactivators in a manner known to persons of skill in the art.

The products produced in accordance with the process of this invention are normally solid, predominantly isotactic polyalpha-olefins. Homopolymer or copolymer yields are sufficiently high relative to the amount of catalyst employed so that useful products can be obtained without separation of catalyst residues. Further, levels of stereorandom by-products are sufficiently low so that useful products can be obtained without separation thereof. The polymeric or copolymeric products produced in the presence of the invented catalyst can be fabricated into useful articles by extrusion, injection molding, thermoforming, and other common techniques.

A propylene polymer made according to this invention primarily contains a high crystalline polymer of propylene. Polymers of propylene having substantial polypropylene crystallinity content now are well-known in the art. It has long been recognized that crystalline propylene polymers, described as “isotactic” polypropylene, contain crystalline domains interspersed with some non-crystalline domains. Noncrystallinity can be due to defects in the regular isotactic polymer chain which prevent perfect polymer crystal formation.

After polymerization, polymer powder is removed from the polymerization reactor by methods known to the art, typically through a separate chamber or blowbox, and preferably transferred to a polymer finishing apparatus in which suitable additives are incorporated into the polymer, which is heated, typically by mechanical shear and added heat, in an extruder to above melt temperature, extruded through a die, and formed into discrete pellets. Before processed by the extruder, polymer powder may be contacted with air and water vapor to deactivate any remaining catalytic species.

### Experimental Runs

This invention is illustrated, but not limited by, the following Experimental Runs.

Polymerization tests were performed in a 5-liter stainless steel vertical reactor vessel equipped with a mechanical agitator and monomer and catalyst injection ports. Polymerization was conducted under oxygen-free and water-free conditions and reaction temperature was controlled with a double envelope heating mantle using a water-steam regulation. Monomer flow rates were measured by mass flowmeters and gas composition was analyzed using a mass spectrometer. In these tests an initial charge of alkylaluminium (TEA or TNOA) and silane (DIPDMS) were added to the reactor at room temperature under a nitrogen blanket followed by 20 g of a granular inert seed bed. The reactor was closed and the nitrogen was purged from the reactor with propylene and hydrogen added for molecular weight control. The reaction medium was homogenized by agitation at 450 rpm. The reactor temperature was set to 62° C. with a monomer and hydrogen total pressure of 8 bars. A high activity magnesium-supported titanium-containing catalyst (69.34 millligrams of Lynx® 1000M (BASF) containing 1.5 wt. % Ti and 20.2 wt % Mg) was injected into the reactor with some propylene at about 12 bars and the polymerization reactor temperature was maintained at 65° C. and a pressure of 10 bars. After one hour additional TEA with silane was injected into the reactor by injection with a slight argon overpressure. At the end of the polymerization time, the reactor was vented and the product isolated. Results are shown in Table 1.

The kinetic model used to describe the polymerization reaction rate is a simplified model which assumes a first-order deactivation rate (kd) and first-order dependence of the reaction rate on monomer and active site concentration. Thus,

kp=kp0*e(−kd*t)

where kp is the polymerization rate (g propylene/h*bar*mg Ti), kp0 is the initial polymerization rate at a time and kd (h−1) is the first order deactivation rate constant.

The rates kp0 and kd for stages 1 and 2 were calculated from polymerization flow rates obtained during about 30 minutes of polymerization after line-out.

The calculated rate constants, kp0 and kd, will vary from batch to batch, especially in the first stage. However a decrease of kd from 0.8 to 0-0.1 during the second stage in significant. In Table 1, a comparison of runs 1, 2 and 5 vs. run 4 shows that staged addition of TEA (with Al/Mg: 9-10) significantly lowered the kd during the second stage and increased total polymer productivity. This shows that staged addition of aluminum alkyl co-catalyst increases production during the second stage period and thereby obtains a more uniform product distribution between the two stages.

TABLE 1

| | Run | | | | | |
|---|---|---|---|---|---|---|
| | 1 | 2 | 3 | 4 | 5 | 6 |
| Stage 1 | | | | | | |
| Al Alkyl added | TEA | TEA | TEA | TEA | TNOA | TNOA |
| Al/Ti (molar ratio) | 60 | 60 | 60 | 60 | 80 | 80 |
| Al/Si (molar ratio) | 1.5 | 1.5 | 1.5 | 1.5 | 3.0 | 3.0 |
| SiTi (molar ratio) | 40 | 40 | 40 | 40 | 26 | 26 |
| kd (hr⁻¹) | 0.6 | 0.7 | 0.9 | 0.7 | 0.4 | 0.4 |
| kp0 (gC₃/h * bar * mgTi) | 38.4 | 32.2 | 40.9 | 32.7 | 34.2 | 40.7 |
| Stage 2 | | | | | | |
| Al Alkyl added | TEA | TEA | TEA | | TEA | TEA |
| Al/Ti (molar ratio) | 120 | 120 | 30 | 0 | 131 | 33 |
| Al/Si (molar ratio) | 1.5 | 3.0 | 0.8 | 0.0 | 3.0 | 0.8 |
| SiTi (molar ratio) | 80 | 40 | 40 | 0 | 44 | 44 |
| kd (hr⁻¹) | 0.0 | 0.1 | 0.7 | 0.8 | 0.0 | 0.3 |
| kp0 (gC₃/h * bar * mgTi) | 23.5 | 22.9 | 29.1 | 35.7 | 27.6 | 39.1 |
| Total Al/Ti (molar ratio) | 180 | 180 | 90 | 60 | 211 | 113 |
| Total Reaction Time (min) | 120 | 120 | 142 | 120 | 120 | 120 |
| Product Analysis | | | | | | |
| Mg (ppm) | 23 | 25 | 24 | 32 | 23 | 20 |
| Ti (ppm) | 1.8 | 2 | 2.1 | 2.5 | 1.8 | 1.6 |
| Productivity (gPP/gCat/h) | | | | | | |
| By Mg analysis | 4167 | 3750 | 3014 | 3000 | 4167 | 4688 |
| By Ti analysis | 4391 | 4040 | 3551 | 3156 | 4391 | 5050 |
| H₂/C₃⁼ (molar ratio) | 0.04 | 0.04 | 0.05 | 0.03 | 0.04 | 0.04 |
| C₂⁼/C₃⁼ (molar ratio) | 0.03 | 0.03 | 0.04 | 0.03 | 0.06 | 0.06 |
| MFR (g/10 min) | 12 | 15 | 15 | 11 | 14 | 20 |
| C₂ total (wt. %) | 5.4 | 4.6 | 4.3 | 3.9 | 4.2 | 5.3 |
| Bulk Density (kg/L) | 0.38 | 0.36 | 0.36 | 0.36 | 0.39 | 0.39 |

A further series of experimental runs of propylene polymerization were performed in a two reactor continuous polymerization reactor system. Each of the two reactors is a 3.8-liter gas-phase, horizontal, cylindrical reactor measuring 10 cm in diameter and 30 cm in length. An inter-stage gas exchange system was located between the two reactors which can capture first reactor polymerization product, be vented to remove first reactor gas, and be refilled with gas from the second reactor. This gas exchange system is present in order to preserve different gas compositions in each reactor stage. The first reactor was equipped with an off-gas port for recycling reactor gas through a condenser and back through a recycle line to nozzles in the reactor. In the first reactor, liquid propylene was used as a quench liquid to help control the temperature of the polymerization. The reactor was operated in a continuous fashion. The second reactor was equipped with an off-gas port for recycling reactor gas but in this case no condenser is present. The second reactor is equipped with a constant temperature bath system to maintain reactor temperature which circulates water to heat transfer coils wrapped around the outside of the reactor.

Polymerization was initiated by introduction of high activity supported titanium containing catalyst component produced in accordance with U.S. Pat. No. 4,886,022 to the first reactor. The titanium-containing catalyst component was introduced as a slurry (0.5 to 1.5 wt %) in hexane through a liquid propylene-flushed catalyst addition nozzle. A mixture of an organosilane modifier (DIPDMS) and trialkylaluminum (TEA or TNHA) co-catalyst in hexane was fed separately to the first reactor through a different liquid propylene-flushed addition nozzle with an Al/Si ratio of 6. During polymerization active polymer powder was captured from the first reactor, exposed to a series of gas venting and re-pressurization steps before the powder was added to the second reactor. Hydrogen was fed to each reactor through a separate Brooks mass-flow meter on each reactor system in order to achieve the desired powder melt flow rate (MFR). Ethylene and propylene were fed separately to the second reactor through mass-flow meters in order to maintain the desired ratio of the two gases.

During these runs the first reactor was lined-out to make a specific melt flow rate homopolymer before the second reactor operation began. This was followed by establishing lined-out operations in the second reactor using a mixture of ethylene and propylene to make a targeted ethylene content in the ethylene-propylene rubber (EPR) phase and a targeted level of EPR segment in the final product. Once lined-out operations were achieved in both reactors, the system was perturbed by adding additional aluminum alkyl to the second reactor. Changes to the final product could be assessed by measuring the change in the resulting level of the EPR segment.

In Runs 7-13, the effects due to staging the same alkyl aluminum between the two reactors were accessed. The experiment was set-up such that TEA was added the first reactor to result in an Al/Ti of 34 (Al/Mg of 2.5), which is lower than a typical value of Al/Mg of 6 (Al/Ti of 80) for the titanium-containing component used in these experiments. Additional TEA was added to the second reactor to result in a final Al/Ti of 102 (Al/Mg of 7.5). Resulting data are broken into two sections. The first section (Runs 7-9) represents lined-out operations before addition of TEA to the second reactor. The second section (Runs 10-13) shows operations when TEA was added to the second reactor. Although gas compositions for the two periods were essentially equivalent, when TEA was added to the second reactor, the percentage of EPR segment added in the second reactor increased by over 30%. Therefore, by operating the first reactor at a reduced TEA concentration and then increasing the TEA concentration in the second reactor, the catalyst productivity in the second reactor was increased.

A second series experiments (Runs 14-18) was conducted to assess the effects due to operating the reactors using different aluminum alkyls. In this experiment TNHA (tri-n-hexyl aluminum) was added to the first reactor at an Al/Ti/ of 55 (Al/Mg of 4). TEA was added to the second reactor to increase the final Al/Ti up to 135 (Al/Mg 10). Again the data are broken into two sections. The first (Runs 14-16) represents lined-out operations before addition of TEA to the second reactor. The second section (Runs 17-18) shows operations when TEA was added to the second reactor. Although gas compositions for the two periods were essentially equivalent, when TEA was added to the second reactor, the percentage of EPR segment added in the second reactor increased by over 60%. Therefore, by operating the first reactor with an aluminum alkyl which is a less potent reducing agent and then adding TEA, which is a stronger reducing reagent, to the second reactor, the catalyst productivity in the second reactor was increased.

Data shown in Table 2 are broken into sections. Averages for each period of operation also are shown. The table lists the hydrogen/propylene (H₂/C₃^{═}) molar ratios in each reactor (R1 and R2), the ethylene to propylene (C₂^{═}/C₃^{═}) molar ratios in the second reactor, the amount of product made in the second reactor (% Seg), the ethylene content of the random copolymer component (RCC2), the total ethylene content of the final product and the MFR (g/10 min) of the final product. MFR was measured according to ASTM D1238, Condition L (230° C., 2.16 Kg load).

TABLE 2

| | R-1 | R-2 | | | | Total | Final |
|---|---|---|---|---|---|---|---|
| Run | H₂/C₃⁼ | H₂/C₃⁼ | C₂⁼/C₃⁼ | % Seg | RCC2 | C₂⁼ | MFR |
| 7 | 0.0585 | 0.00657 | 0.47793 | 8.8 | 52.2 | 4.6 | 14.1 |
| 8 | 0.05819 | 0.00633 | 0.40996 | 10.7 | 48.7 | 5.2 | 12.8 |
| 9 | 0.06209 | 0.00587 | 0.3452 | 9.8 | 46.7 | 4.6 | 13.3 |
| Average | 0.0596 | 0.0063 | 0.4110 | 9.8 | 49.2 | 4.8 | 134 |
| of Runs | | | | | | | |
| 7-9 | | | | | | | |
| 10 | 0.05985 | 0.00622 | 0.36398 | 12.6 | 45.6 | 5.8 | 12.2 |
| 11 | 0.05793 | 0.00649 | 0.41733 | 11.1 | 49.4 | 5.5 | 12.4 |
| 12 | 0.06114 | 0.00677 | 0.44447 | 13.6 | 48.6 | 6.6 | 13.6 |
| 13 | 0.06167 | 0.00691 | 0.45008 | 15.6 | 49.3 | 7.7 | 10.5 |
| Average | 0.0601 | 0.0066 | 0.4190 | 13.2 | 48.2 | 6.4 | 12.2 |
| of Runs | | | | | | | |
| 10-13 | | | | | | | |
| 14 | 0.05253 | 0.00664 | 0.42548 | 25.1 | 51.4 | 12.9 | 7.4 |
| 15 | 0.05324 | 0.00627 | 0.42935 | 28.8 | 56.1 | 16.2 | 5.7 |
| 16 | 0.05527 | 0.00584 | 0.48536 | 26.8 | 52.3 | 14 | 7.1 |
| Average | 0.0537 | 0.0063 | 0.4467 | 26.9 | 53.3 | 14.4 | 6.7 |
| of Runs | | | | | | | |
| 14-16 | | | | | | | |
| 17 | 0.05767 | 0.00485 | 0.43707 | 46.2 | 57.5 | 26.5 | 2.5 |
| 18 | 0.05565 | 0.00483 | 0.40251 | 43.2 | 54 | 23.3 | 3.5 |
| Average | 0.0567 | 0.0048 | 0.4198 | 44.7 | 55.8 | 24.9 | 3 |
| of Runs | | | | | | | |
| 17-18 | | | | | | | |

What is claimed is:

1. An olefin polymerization process comprising gas-phase polymerization of at least one olefin monomer in more than one polymerization zones using a high activity Ziegler-Natta catalyst system comprising a solid, magnesium-supported, titanium-containing component and an aluminum alkyl co-catalyst component comprising:
a) introducing the titanium-containing component and an aluminum alkyl component into the first polymerization zone; and
b) introducing additional aluminum alkyl component into a subsequent polymerization zone without added titanium-containing component.

2. A process of claim 1 in which the olefin is propylene or a mixture of propylene and ethylene.

3. A process of claim 1 in which propylene is polymerized in a first reaction zone and a mixture of propylene and ethylene are polymerized in a second polymerization zone.

4. A process of claim 1 in which aluminum alkyl is added to two polymerization zones.

5. A process of claim 1 in which the aluminum alkyl component is triethylaluminum.

6. A process of claim 1 in which triethylaluminum is added in a first polymerization zone and a C₃-C₁₂ alkyl aluminum co-catalyst component is added to a second polymerization zone.

7. A process of claim 1 in which a C₃-C₁₂ aluminum alkyl co-catalyst component is added to a first reaction zone and triethylaluminum is added to a second polymerization zone.

8. A process of claim 1 in which different hydrogen concentrations are used in the different reaction zones.

9. A process of claim 1 in which organosilane is added to the polymerization as an external electron donor.

10. A process of claim 9 in which different organosilane external electron donors are added in different polymerization zones.

11. A process of claim 9 in which different aluminum/silicon molar ratios are used in different polymerization zones.

12. A process of claim 1 in which a mixture of aluminum alkyl co-catalyst components are used.
